(19) United States
(12) Patent Application Publication
(10) Pub. No.: US 2022/0277613 A1
(43) Pub. Date: Sep. 1, 2022

(54) GAMING SYSTEMS AND METHODS USING DETERMINED OUTCOME SEQUENCES

(71) Applicant: SG Gaming, Inc., Las Vegas, NV (US)

(72) Inventors: Richard MILOSEVICH, Las Vegas, NV (US); George BOUVIER, Henderson, NV (US); Kenneth Shawn SOONG, Henderson, NV (US)

(21) Appl. No.: 17/541,334

(22) Filed: Dec. 3, 2021

Related U.S. Application Data
(60) Provisional application No. 63/154,154, filed on Feb. 26, 2021.

(51) Int. Cl. G07F 17/32; G07F 17/34

(52) U.S. Cl. CPC G07F 17/3213; G07F 17/3267; G07F 17/34

(57) ABSTRACT

A gaming machine comprising a display device and game-logic circuitry is provided. The display device presents a plurality of symbol positions and a plurality of symbol reels, each symbol reel comprising symbols and associated with at least one symbol position. The game-logic circuitry causes the display device to present a first game outcome by populating each symbol position with a symbol from the symbol reels; causes, in response to a trigger event, the display device to lock at least one symbol reel; causes the display device to present an unlocked symbol reel incrementing through at least a majority of its symbols by populating the associated symbol positions with a respective new symbol for each increment; determines, for each increment, a game outcome based on the symbols currently populating the symbol positions; and causes the display device to present an award animation for any winning game outcomes.

### CROSS-REFERENCE TO RELATED APPLICATIONS

This application claims the benefit of priority to U.S. Provisional Patent Application No. 63/154,154, filed Feb. 26, 2021, the contents of which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2021, SG Gaming, Inc.

### FIELD

The present disclosure relates generally to gaming systems, apparatus, and methods and, more particularly, to game features incorporating one or more symbol sequences that are incremented to generate a plurality of game outcomes.

### BACKGROUND

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

As the industry matures, the creativity and ingenuity required to improve such operation of gaming apparatus and games grows accordingly.

### SUMMARY

According to one aspect of the present disclosure, a gaming machine comprising a display device and game-logic circuitry is provided. The display device presents a plurality of symbol positions and a plurality of symbol reels, each symbol reel comprising a plurality of symbols and associated with at least one symbol position. The game-logic circuitry causes the display device to present a first game outcome by populating each symbol position with a symbol from the associated symbol reel; causes, in response to a trigger event, the display device to lock at least one symbol reel, wherein the symbols of the locked symbol reel that populate the symbol positions are locked into the respective symbol positions; causes the display device to present an unlocked symbol reel incrementing through at least a majority of its symbols by populating the symbol positions associated with the unlocked symbol reel with a respective new symbol for each increment; determines, for each increment, a game outcome based on the symbols currently populating the symbol positions; and causes the display device to present an award animation for any winning game outcomes.

According to another aspect of the present disclosure, a method for presenting a game using a gaming machine is provided. The method comprises presenting, by a display device of the gaming machine, a plurality of symbol positions and a plurality of symbol reels, each symbol reel of the plurality of symbol reels comprising a plurality of symbols and associated with at least one symbol position of the plurality of symbol positions; causing, by game-logic circuitry of the gaming machine, the display device to present a first game outcome by populating each symbol position of the plurality of symbol positions with a symbol from the associated symbol reel of the plurality of symbol reels; causing, by the game-logic circuitry and in response to a trigger event, the display device to lock at least one symbol reel of the plurality of symbol reels, wherein the symbols of the at least one locked symbol reel that populate the plurality of symbol positions are locked into the respective symbol positions; causing, by the game-logic circuitry, the display device to present an unlocked symbol reel of the plurality of symbol reels incrementing through at least a majority of the plurality of symbols of the unlocked symbol reel by populating the symbol positions associated with the unlocked symbol reel with a respective new symbol from the plurality of symbols for each increment; determining, by the game-logic circuitry and for each increment of the unlocked symbol reel, a game outcome based on the symbols currently populating the plurality of symbol positions; and causing, by the game-logic circuitry, the display device to present an award animation for any winning game outcomes from the determined game outcomes and the first game outcome.

According to yet another aspect of the present disclosure, a gaming system comprising a gaming machine and game-logic circuitry is provided. The gaming machine includes a display device configured to present a plurality of symbol positions and a plurality of symbol reels, each symbol reel of the plurality of symbol reels comprising a plurality of symbols and associated with at least one symbol position of the plurality of symbol positions. The game-logic circuitry is configured to: cause the display device to present a first game outcome by populating each symbol position of the plurality of symbol positions with a symbol from the associated symbol reel of the plurality of symbol reels; in response to a trigger event, cause the display device to lock at least one symbol reel of the plurality of symbol reels, wherein the symbols of the at least one locked symbol reel that populate the plurality of symbol positions are locked into the respective symbol positions; cause the display device to present an unlocked symbol reel of the plurality of symbol reels incrementing through at least a majority of the plurality of symbols of the unlocked symbol reel by populating the symbol positions associated with the unlocked symbol reel with a respective new symbol from the plurality of symbols for each increment; determine, for each increment of the unlocked symbol reel, a game outcome based on the symbols currently populating the plurality of symbol positions; and cause the display device to present an award animation for any winning game outcomes from the determined game outcomes and the first game outcome.

Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to one or more embodiments of the present disclosure.

FIG. 2 is a schematic view of a gaming system according to one or more embodiments of the present disclosure.

FIG. 3 is an image of an exemplary basic-game screen of a wagering game displayed on a gaming machine, according to one or more embodiments of the present disclosure.

FIG. 4 is a flow diagram of an example gaming method using incremental outcome sequences, according to one or more embodiments of the present disclosure.

FIG. 5 is an example game interface in a trigger state including a trigger condition for a bonus feature, according to one or more embodiments of the present disclosure.

FIG. 6A is the example game interface shown in FIG. 5 in an initial state of a bonus feature, according to one or more embodiments of the present disclosure.

FIG. 6B is an example unlocked symbol reel used in the game interface shown in FIG. 6A, according to one or more embodiments of the present disclosure.

FIG. 7A is the game interface shown in FIG. 6A in a second state after a single increment of an unlocked symbol reel, according to one or more embodiments of the present disclosure.

FIG. 7B is the example unlocked symbol in the state shown in FIG. 7A, according to one or more embodiments of the present disclosure.

FIG. 8A is the game interface shown in FIG. 7A in a third state after a second increment of the unlocked symbol reel, according to one or more embodiments of the present disclosure.

FIG. 8B is the example unlocked symbol in the state shown in FIG. 8A, according to one or more embodiments of the present disclosure.

FIG. 9A is the game interface shown in FIG. 7A in a fourth state after five increments of the unlocked symbol reel from the initial state, according to one or more embodiments of the present disclosure.

FIG. 9B is the example unlocked symbol in the state shown in FIG. 8A, according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

For purposes of the present detailed description, the terms “increment,” “incremental,” “stepping,” and/or other similar terms may be used to convey the action of replacing a presented game symbol with another symbol from a set of symbols (e.g., a reel strip of symbols). This action may be performed mechanically (e.g., rotating a mechanical reel), digitally (e.g., replacing the graphical icon of the old symbol with the icon of the new symbol), or combinations thereof. It is to be understood that the old symbol and new symbol may have the same presentation and/or functionality (e.g., a “cherry” symbol may be replaced with another “cherry” symbol). Moreover, the order in which symbols are replaced may be predefined or dynamically defined. For example, a symbol reel may have a cyclical order in which the symbols are presented, and the increment described herein may shift the presented symbol to the next reel position on the symbol reel. In such an example, the increments may not be limited to shifting a single reel position, but rather may include other operations, such as shifting a plurality of reel positions and/or “jumping” to a different reel position. In another example, the new symbol may be selected randomly from a set of symbols lacking predefined order such that the remaining symbols may be selected during subsequent increments.

The systems and methods described herein may include a game feature for incrementing through a plurality of symbols to generate a plurality of game outcomes. More specifically, in at least some embodiments, a trigger condition detecting during a base game outcome initiates the bonus game and causes a symbol array to be divided into locked symbol positions (i.e., the symbols remain fixed in the symbol positions) and unlocked symbol positions. For each of the unlocked symbol positions, a respective set of symbols (e.g., a symbol reel) may be incremented through a plurality of available symbols to replace the initial symbol in the respective unlocked symbol position. For each increment, the systems described herein determine a game outcome based on the current symbols populating the symbol array. In certain embodiments, the systems and methods described herein may increment though every available symbol for a given symbol position until the locked symbol positions are unlocked. The bonus game feature may continue or may conclude at this point to return to the base game feature.

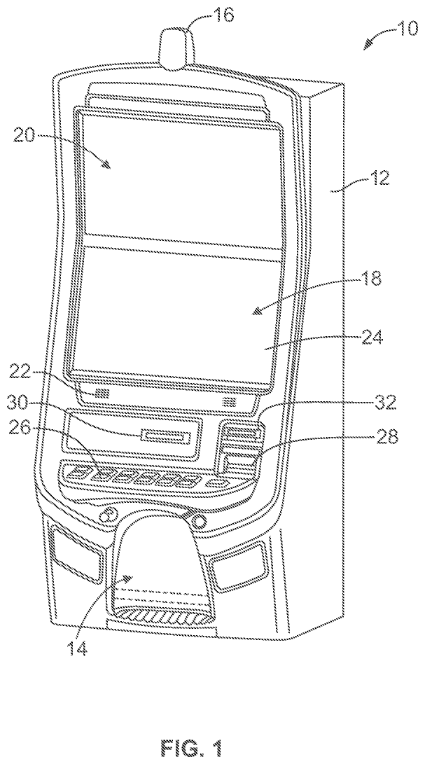

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

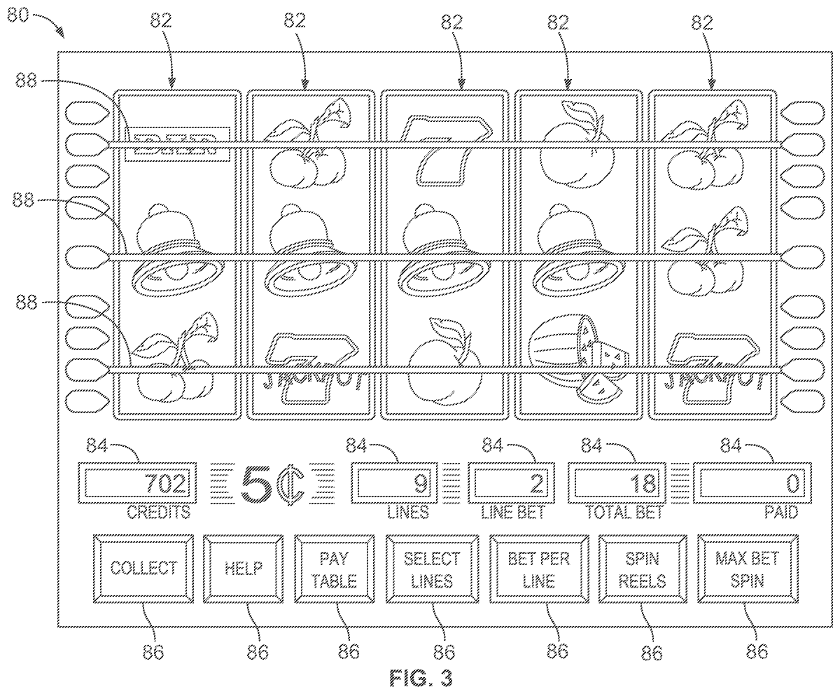

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

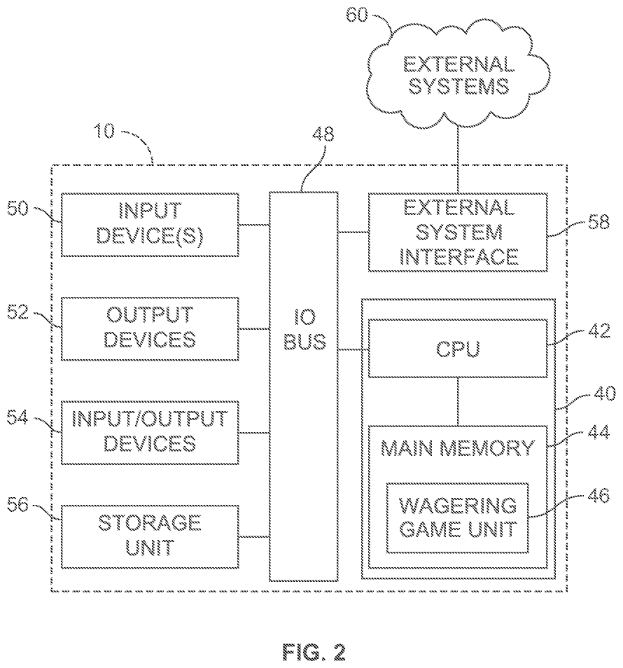

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

As described above, the systems and methods described herein may include a bonus game feature that incrementally replaces symbols in one or more symbol positions to generate a plurality of game outcomes, which may result in a plurality of winning game outcomes. For embodiments incorporating symbol reels (digital, mechanical, and/or electromechanical reels) that each have a plurality of symbols, one or more symbol reels may be locked in place while one or more additional symbol reels are incremented though at least a portion of the symbols on the unlocked symbol reel. The increments may be based on a mathematical or logical operation different from a spin operation (i.e., randomly selecting a symbol from the symbol reel). For each increment, a game outcome is determined to identify any winning outcomes. Performing a plurality of increments results in a plurality of game outcomes being generated, thereby increasing the number of opportunities for winning outcomes.

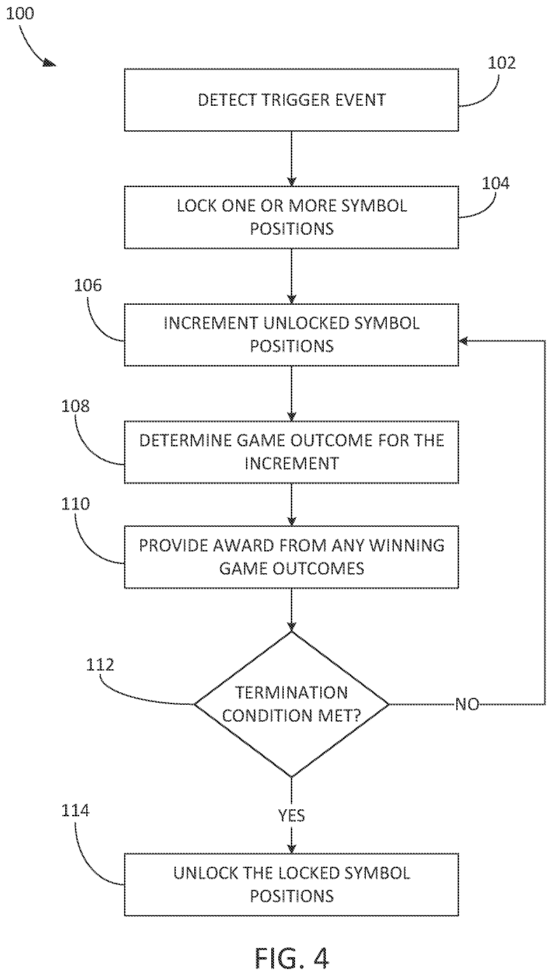

FIG. 4 is a flow diagram of an example method 100 for conducting a game with an incremental outcome feature. The method 100 may be conducted using a gaming machine (e.g., the machine 10, shown in FIG. 1) and/or other suitable device, such as a mobile phone. The steps of the method 100 may be performed using game-logic circuitry, such as the game-logic circuitry 40 shown in FIG. 2, and the game-logic circuitry may cause one or more additional components to perform at least some of the functions described herein. In other embodiments, the method 100 may include additional, fewer, or alternative steps, including those described elsewhere herein.

In the example embodiment, a base game feature may be provided or administered by the logic circuitry. The base game feature may include a plurality of symbol positions that are selectively populated with symbols (e.g., the game interface shown in FIG. 3). At step 102, a trigger event or condition is detected based on the base game feature. In one example, a trigger symbol, combination of trigger symbols, trigger watermark (i.e., a visual element that can occupy a symbol position simultaneously to a symbol, such as a color background), and/or predefined trigger indicia may be detected in an outcome of the base game feature. In another example, a threshold relating to wager amount, wager frequency, player tracking points, game points, and/or other suitable tracked metrics may be reached to activate the trigger event. In yet another example, one or more random determinations external to the random number generation used to generate the base game outcome may be used to active the trigger condition. In certain embodiments, a plurality of conditions may together form the trigger event or condition. For example, the trigger symbol may not activate the trigger event without a wager threshold being achieved. In another example, the trigger condition may include achieving a threshold number of trigger symbols within a predefined number of base game outcomes (e.g., five or ten). In response to the trigger condition, a bonus game feature is initiated.

At step 104, the bonus game feature is initiated, and one or more symbol positions of the plurality of symbol positions are locked. In this context, “locked” refers to the symbols remaining in their respective symbol position for a plurality of game outcomes as described herein. The symbol positions may be locked with the symbols from the final base game outcome before the bonus game feature, or the symbol positions may be locked with a new set of symbols. The locking action may be conveyed to the player through one or more animations or changes to the locked symbol positions. For example, a border graphic (e.g., lock and chains, ice, etc.) may be applied to the locked symbol positions to indicate the symbol positions are locked. In another example, the locked symbol positions may change color or one or more lights that shine on the locked symbol positions (particularly for mechanical systems) may be turned off or change color. These animations or other visual changes enable the player to readily distinguish between the locked symbol positions and one or more remaining unlocked symbol positions.

In the example embodiment, at least one symbol position of the plurality of symbol positions remain unlocked in the bonus game feature. The unlocked symbol positions may have an altered appearance to distinguish from the locked symbol positions or may remain unchanged to indicate to the player that these symbol positions are unlocked.

At step 106, the unlocked symbol positions are incremented at least once. Incrementing one of the unlocked symbol positions causes the symbol populating the unlocked symbol position to be replaced with another symbol from a set of symbols associated with the unlocked symbol position. Unlike a traditional “spin,” where random-number generation is used to select the new symbol (which may be the preexisting symbol), the increment described above may incorporate a mathematical or logical operation to select the new symbol. For example, if the set of symbols has a predefined order (e.g., a symbol reel), a shift operation may be performed such that the next symbol in the predefined order replaces the preexisting symbol. Other suitable operations may be performed, including shift operations that shift more than one position in the predefined order. It is to be understood that although random selection may not be used in the same manner as a traditional spin, some operations may include the use of random-number generation (e.g., to determine the extent of the shift operation to be performed).

If the symbol positions include a plurality of unlocked symbol positions, the unlocked symbol positions may be incremented together (e.g., a column of symbol positions incremented together) or separately. In embodiments with separate increments, the unlocked symbol positions may be incremented using any suitable order or sequence. For example, a first symbol position may be incremented through the entirety of the set of symbols associated with the first symbol position prior to any increments of a second unlocked symbol position. In another example, the first symbol position may be incremented once, and then the second symbol position is incremented once prior to the next increment of the first symbol position.

In at least some embodiments, the symbol positions are associated with symbol reels, and each symbol reel includes a plurality of symbols for populating the associated symbol positions. More specifically, a subset of each symbol reel is selected to populate the associated symbol position(s) through random selection or the incremental operations described above. The size of the subset is dependent upon the number of symbol positions associated with a given reel strip. For example, if one symbol position is associated with the reel strip, then the subset is one symbol wide. If three symbol positions are associated with the symbol reel, then the subset is three symbols wide. The subset may be tied to reel position (i.e., the order of the symbols on the symbol reel) or be freely chosen from the symbols of the symbol reel (though subsequent operations on during the increments of step 106 may still be based on reel position). In the embodiments with symbol reels, it is to be understood that the symbol reels may be locked or unlocked such that the animations and/or other visual differences between locked and unlocked symbol positions may be applied to the reels rather than the individual symbol positions, particularly for embodiments in which a symbol reel spans multiple symbol positions.

At step 108, for each increment of the unlocked symbol positions, a game outcome may be determined based on the symbols current populating the locked and unlocked symbol positions. Determining a game outcome may include, for example, detecting any combination of symbols or single symbol that results in an award (e.g., a credit award, bonus increments, free spins, etc.), a change in the game, and/or other events associated with play of the bonus game feature. At step 110, an award is provided if the determined game outcome is a winning outcome. Although the step 110 is shown as a repeating step in the method 100 for each increment, it is to be understood that winning game outcomes may be awarded together in a single, aggregated award sequence (e.g., at the conclusion of the bonus game feature). The display device may be configured to present an award animation accompanying any identified winning game outcome. At step 112, the game-logic circuitry determines if a termination condition has been met. The termination condition may be, for example, a threshold amount of increments, a time threshold, detecting a symbol or combination of symbols representing the termination condition, and/or other suitable events or sequences. If the termination condition is met, the locked symbol positions are unlocked at step 114. This may be conveyed to the player by presenting an animation or other suitable audiovisual cue to return the locked and unlocked symbol positions to a similar state. In certain embodiments, the bonus game feature may conclude in response to the termination condition to return the game to the base game feature. In other embodiments, the bonus game feature may continue is a different state. For example, the bonus game feature may include a number of free spins or game outcomes, and achieving the trigger condition again during the free spins may cause the system to return to the state described by the method 100.

If the termination condition has not been met, the game-logic circuitry continues at step 106 for an additional increment of the unlocked symbol positions. Steps 106-112 may continue to repeat for subsequent increments until the termination condition is met. In some embodiments, the unlocked symbol positions are incremented through every symbol of the respective set of symbols. In other embodiments, the unlocked symbol positions are incremented through less than or more than (i.e., some symbols populate the symbol position a plurality of increments) all of the symbols of the respective set of symbols. For example, the unlocked symbol positions may be incremented through a majority (i.e., greater than or equal to 50% of the number of symbols) of the set of symbols. In another example, the unlocked symbol positions may be incremented through at least 25% and up to 100% of the symbol set, where the number of increments is dynamically determined.

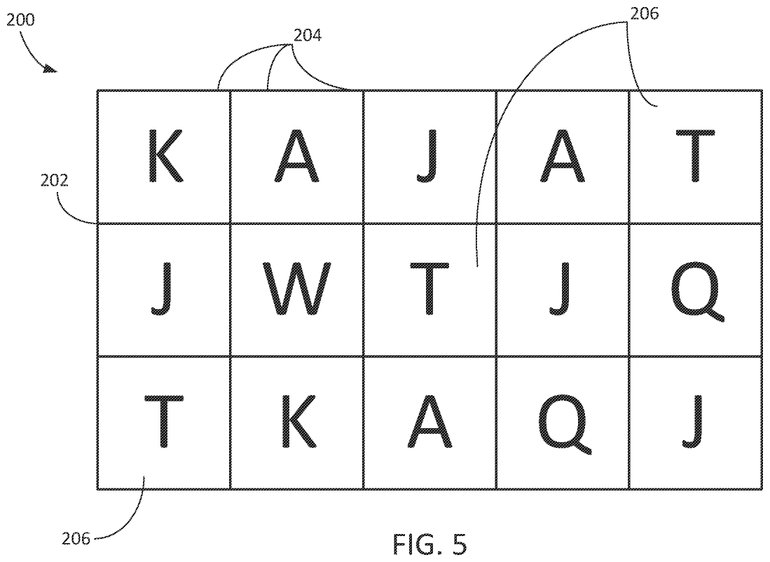

FIGS. 5-9B depict an example gaming interface of a gaming machine (e.g., the gaming machine 10 shown in FIG. 1) for implementing a game feature the same or similar to the feature described with respect to FIG. 4. More specifically, FIGS. 5-9B depict a gaming interface 200 with a symbol array 202 of symbol positions that are populated with symbols from a plurality of symbol reels 204. In the example embodiment, each symbol reel 204 is associated with a column of the symbol array 202 (i.e., three vertically aligned symbol positions) such that three symbols of the symbol reel 204 populate the symbol array 202 at a given time. In other embodiments, the symbol array 202 may have different dimensions, thereby reducing or increasing the number of symbol reels 204 and/or the number of symbol positions associated with a symbol reel 204. In further embodiments, the symbol reels 204 may be associated with a different subset of the symbol array 202, including configurations in which each reel 204 is associated with a single symbol position of the array 202.

It is to be understood that although the interface 200 may be described herein as a graphical user interface of a gaming machine, other implementations incorporating electromechanical reels are contemplated by the present disclosure. In the example embodiment, the game feature is a bonus game feature of a wagering game that includes at least the bonus game feature and a base game feature (e.g., the game feature shown in FIG. 3). In other embodiments, the game feature may be implemented in another suitable configuration and/or within another suitable game (including non-wagering games).

FIG. 5 depicts the gaming interface 200 at a trigger state. More specifically, the trigger state is the state of the base game feature including the trigger condition for the bonus game feature. In the example embodiment, the trigger condition may include at least three trigger symbols 206 populating the symbol array 202 in a base game outcome. In other embodiments, the trigger condition may include different conditions. For example, the threshold of trigger symbols 206 may be more or less (including one) than three. In another example, the trigger condition may require the trigger symbol 206 to be included in a winning symbol combination. In a further example, a particular symbol combination, trigger watermark, wager amount, wager frequency, player account activity, point threshold, and/or the like may be the trigger condition. The trigger symbol 206 may be used by the base game feature to form winning symbol combinations or solely used to trigger the bonus game feature. The trigger symbol 206 may be static or dynamic in the base game feature. For example, the trigger symbol 206 may be dynamic through a selection process in which a symbol for the base game feature is identified as the trigger symbol 206 (e.g., by random selection, based on wager activity or player account activity, and/or based on player input selecting the trigger symbol).

In at least some embodiments, during the bonus game feature described herein, the trigger symbols 206 may function as wild symbols regular symbols (similar to the “A,” “K,” “Q,” and “J” symbols shown), and/or other suitable special symbols. In other embodiments, the trigger symbols 206 may be replaced with other symbols. In certain embodiments, the trigger symbols 206 may remain and not be incorporated into winning game outcomes of the bonus game feature.

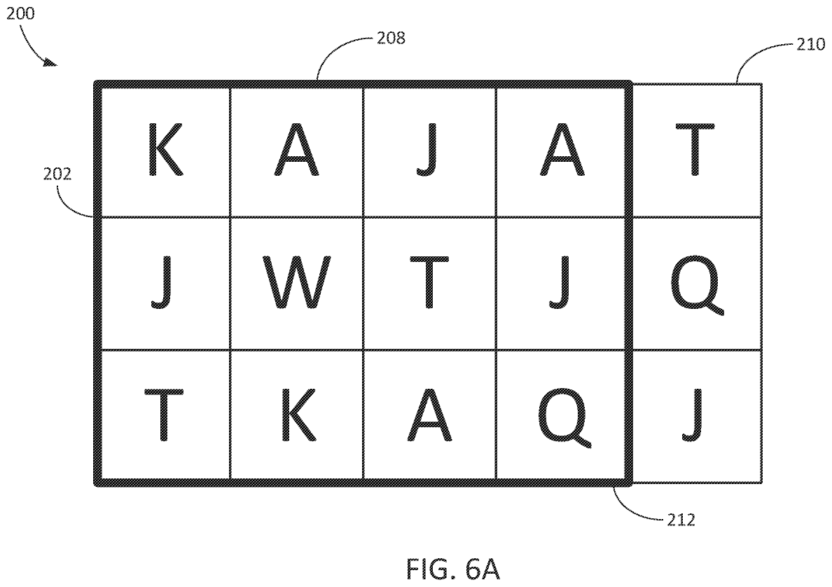

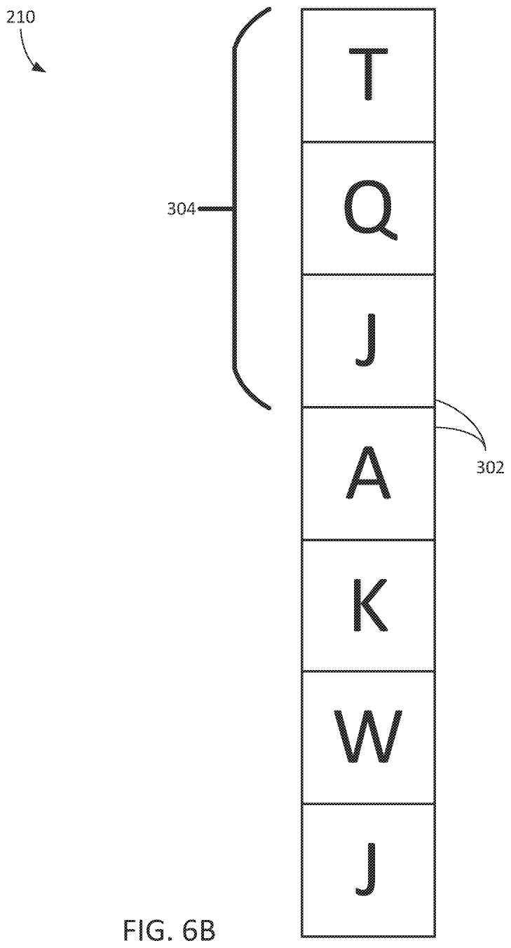

FIG. 6A is the gaming interface 200 at an initial state of the bonus game feature. In the example embodiment, the symbols populating the symbol array 202 at the trigger state of the base game feature remain in the symbol array 202. In other embodiments, the bonus game feature may be initiated with an initial spin or game outcome that populates the symbol array 202 with new symbols from the symbol reels 204.

In the example embodiment, of the four symbol reels 204, the first four symbol reels 204 from the left of the array 202 are locked in the initial state of the bonus game feature. These symbol reels 204 may be referred to herein as locked symbol reels 208. The symbols of the locked symbol reels 208 remain fixed in the symbol array 202 until the locked symbol reels 208 are unlocked. In this embodiment, the rightmost symbol reel 204 remains unlocked for the incrementing feature described herein. This symbol reel 204 may be referred to herein as the unlocked symbol reel 210. In other embodiments, other suitable configurations of locked symbol reels 208 and unlocked symbol reels 210 may be used. For example, the leftmost symbol reel 204 may be unlocked instead of or in addition to the rightmost symbol reel 204. In certain embodiments, dividing the symbol reels 204 between locked reels 208 and unlocked reels 210 may be dynamic for each initiation of the bonus game feature. The locked and/or unlocked symbol reels 208, 210 may be selected randomly, based on the trigger condition, and/or any other suitable aspect related to the bonus game feature (e.g., players may select the unlocked symbol reel 210 in the initial state).

To aid the player in identifying the distinction between the locked symbol reels 208 and the unlocked symbol reel 210, the display device presenting the interface 200 may be configured to present additional display elements, change the preexisting display elements, and/or present animations indicating the state of each symbol reel 204. In the example embodiment, a border 212 is presented around the symbol positions of the locked symbol reels 208. In one example, the symbol positions of the locked symbol reels 208 may be animated to appear frozen or locked. In another example, the color of the locked symbol reels 208 and/or the unlock symbol reel 210 may change to be readily distinguished from one another. For embodiments with electromechanical symbol reels, the surrounding lighting for the symbol reels may change, or a transmissive display in front of the symbol reels may present graphical elements overlapping the symbol reels to identify the locked and unlocked symbol reels 208, 210.

From the initial state, the unlocked symbol reel 210 is incremented through at least a portion of the symbols comprising the symbol reel 210. FIG. 6B depicts an example unlocked symbol reel 210, which may be the same or similar to the locked symbol reels 208, in the initial state shown in FIG. 6A. The symbol reel 210 is divided into a plurality of reel positions 302, where each reel position includes a symbol. In the example embodiment in which the unlocked symbol reel 210 is associated with a column of three symbol positions, three reel positions 302 may be visible within the symbol array in a game outcome. For example the three symbols in the reel positions 302 identified by bracket 304 are the symbols populating the array 202 currently. The reel positions 302 may be used for conveying an order to the set of symbols included within the unlocked symbol reel 210. For example, a spinning animation of the symbol reel 210 may involve rotating through the symbols in the sequence of the reel positions 302, where reaching the end of the symbol reel 210 causes the sequence to repeat from the first reel position 302. The symbol reel 210 may be modifiable to add, remove, replace, clone, and/or reposition symbols. The changes to the symbol reel 210 may affect play of the wager game (i.e., by changing the symbols comprising the symbol reel 210) or be used for animation purposes, such as to clump together symbols having the same symbol type. It is to be understood that the configuration of the symbol reel 210 shown in FIG. 6B is for illustrative purposes only and is not intended to limit the configuration of the symbol reel 210. For example, longer or shorter symbol reels may be used.

In the example embodiment, incrementing the unlocked symbol reel 210 refers to the process of updating the displayed symbols from the unlocked symbol reel 210 through non-random mathematical or logical operation, such as a shift operation. A shift operation in this context involves shifting one or more reel positions to present a new (or partially new) set of displayed symbols from the unlocked symbol reel. Although the embodiment described herein includes shift operations of a single reel position per increment, it is to be understood that the shift operation may shift by a different number of reel positions, such as three. In other embodiments, other suitable operations may be performed for each increment. The operations performed for each increment may be distinct from the random selection performed for a “spin” or base game outcome. For example, in at least some embodiments, the operation performed for each increment may include no random-number generation.

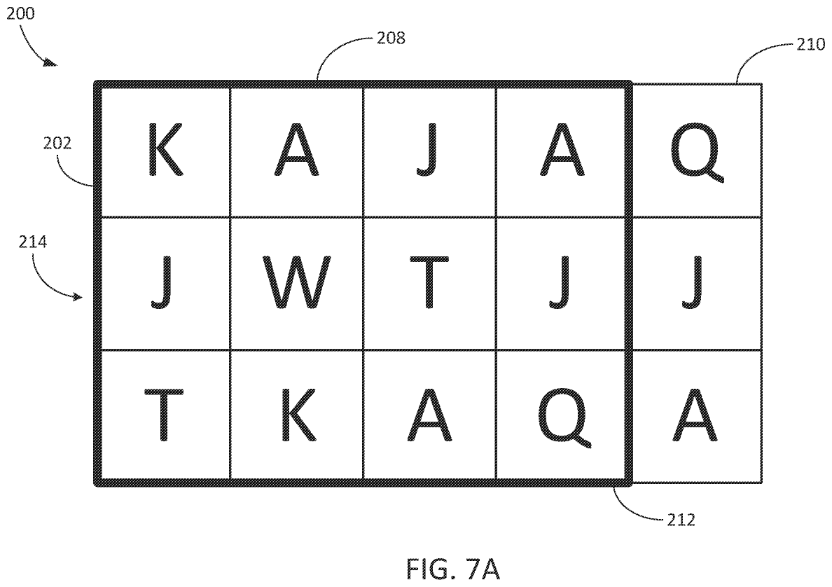

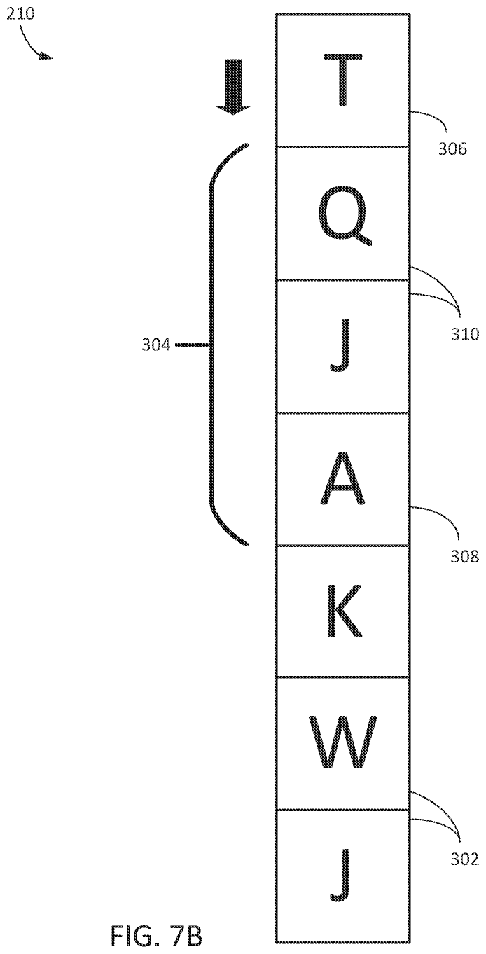

FIG. 7A depicts the gaming interface 200 after a single increment in a second state, and FIG. 7B depicts the unlocked symbol reel 210 in the second state. As indicated by the change in the bracket 304 between FIGS. 6B and 7B, the symbol at reel position 306 is no longer displayed in the array 202, while the symbol at reel position 308 is added to the array 202. The other displayed symbols at reel positions 310 remain in the array 202 as shown in FIG. 7A, but are shifted upwards by a symbol position. Although the symbols are presented as moving upwards, other configurations may include the symbols moving in a different direction, such as downwards.

The logic circuitry of the gaming machine conducting the bonus game feature may cause the display device presenting the interface 200 to present one or more animations associated with the increment. For example, the symbol reel 210 may be animated to rotate to the new state shown in FIG. 7A. The symbol reel 210 may be animated to rotate through other states and settle upon the second state, similar to a predefined reel spin, or the symbol reel 210 may be animated to move directly to the second state and then on to additional subsequent states as described herein.

As described above with respect to FIG. 4, a game outcome is determined for each increment based on the currently presented symbols in the symbol array 202. This includes the symbols of the locked symbol reels 208 and the symbols from the unlocked symbol reel 210. In the example embodiment, the “W” symbols are wilds, and the trigger symbols “T” are treated as wilds in the bonus game feature. As a result, a winning combination of symbols is identified at row 214 of the symbol array 202 in the second state. It is to be understood that the winning combination along the row 214 is for exemplary purposes only, and that other winning combinations may be present in the second state shown in FIG. 7A. The winning combinations are not limited to line pays, but rather may include any suitable form of combining symbols to determine winning game outcomes (e.g., scatter pays).

The logic circuitry may cause the display device presenting the game interface 200 to present one or more award animations for any winning outcomes for a given increment. In some embodiments, the award animation may include one or more graphical elements that aggregate the awards from the bonus game feature until the bonus game feature or the incrementing is completed, which may then be awarded to the player as a single, aggregated award. In other embodiments, the awards are provided to the player in response to presenting the associated winning outcome.

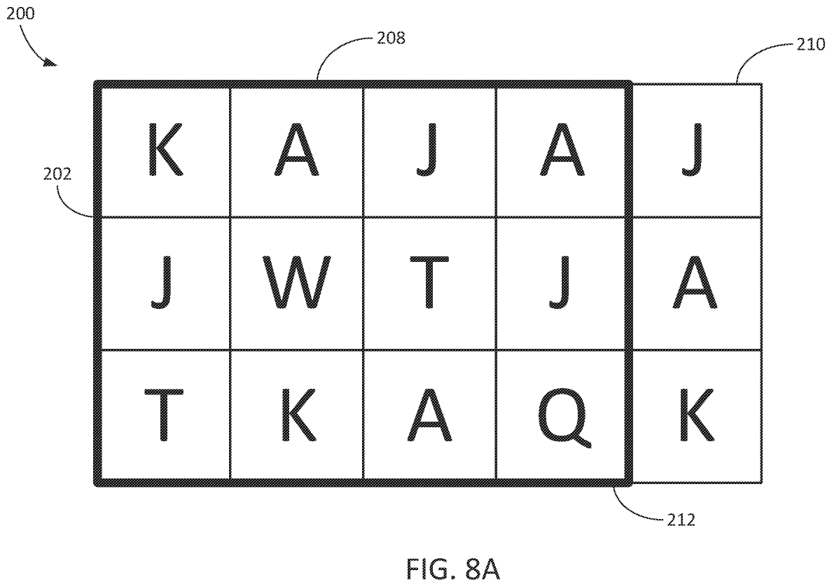

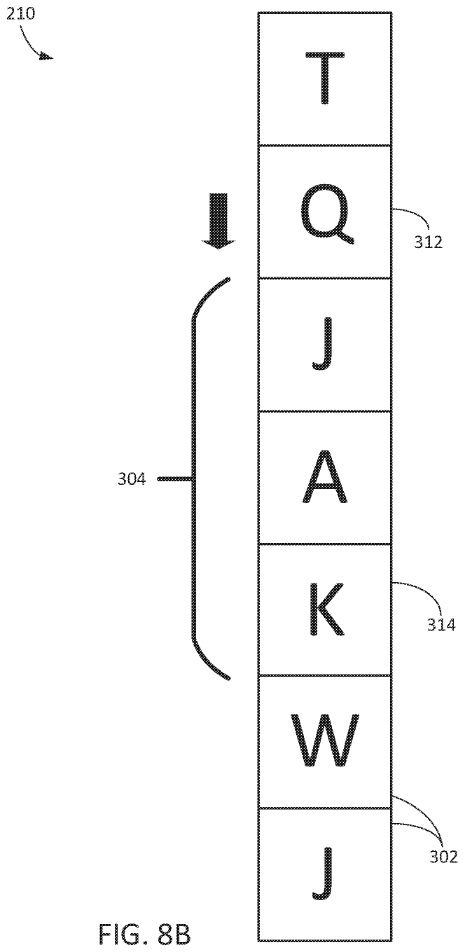

FIG. 8A depicts the gaming interface 200 in a third state after a second increment following the second state shown in FIG. 7A. FIG. 8B depicts the reel strip of the unlocked symbol reel 210 in the third state. The transition between the second and third state may be similar to the transition between the initial state and the second state. That is, in FIG. 8B, the bracket 304 has shifted right by another reel position 302 away from the symbol at reel position 312 and to encompass the symbol at reel position 314. This change is reflected in the symbol array 202 in FIG. 8A, where the symbol of the reel position 312 is removed from the array 202 and the symbol from the reel position 314 is added. The remaining two symbols from the unlocked symbol reel 210 are shifted upwards within the array 202. In at least some embodiments, the direction of the shifting animation may be the same direction as a spin animation or opposite the spin animation.

Similar to the second state, a game outcome may be determined by the logic circuitry based on the third state. More specifically, if any winning outcomes or symbol combinations are identified within the symbol array 202, an award is provided to the player. In some embodiments, the plurality of game outcomes from every increment may be determined together at once rather than determining each game outcome after the associated increment is presented. As the increments may not be based on random selection, the symbols populating the array 202 for each increment is predetermined from the initial state of the bonus game, thereby enabling the logic circuitry to determine the game outcomes without requiring additional player input. By determining and storing the plurality of game outcomes at once, the logic circuitry may retrieve and/or generate one or more animations for the bonus game feature based on the determined outcomes. For example, the logic circuitry may identify which game outcomes are winning outcomes, and the animation for the increments may be adjusted to highlight these winning outcomes. The logic circuitry may cause the display device to present only a subset of the game outcomes from the increments, where the subset includes the winning outcomes. The logic circuitry may cause the display device to present the increments in a different order to spread out the winning outcomes or to save the winning outcomes to be the last increments shown. In other embodiments, each game outcome may be determined and presented in sequence.

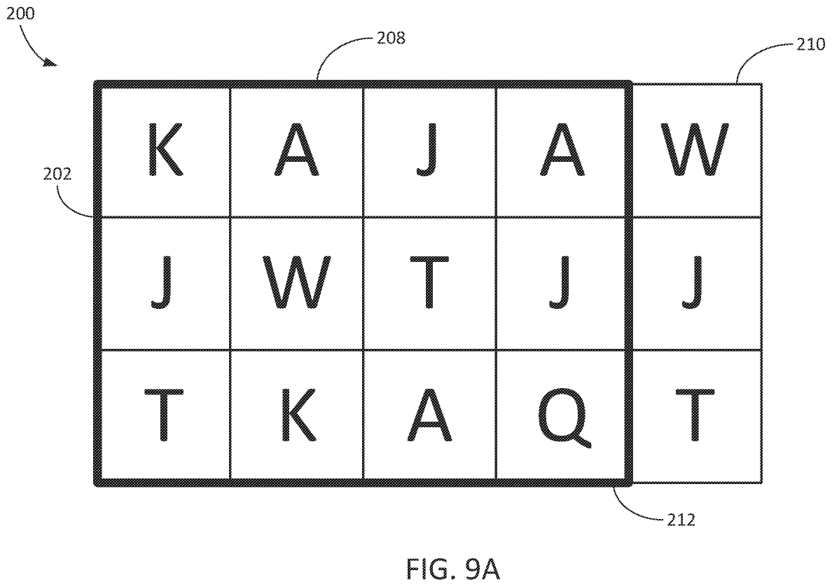

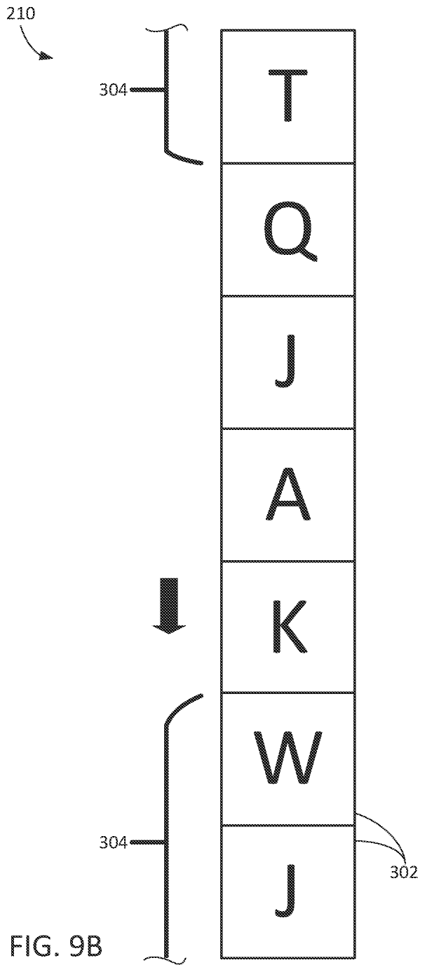

FIG. 9A depicts the example game interface 200 in a fourth state, and FIG. 9B depicts the reel strip of the symbol reel 210 in the fourth state. The fourth state is several increments after the third state as can be seen by the movement of the bracket 304 in FIG. 9B from the bracket 304 shown in FIG. 8B. More specifically, with each increment shifting the bracket by one reel position 302, the fourth state is three increments after the third state. As can be seen in FIG. 9B, as the bracket 304 reaches the end of the reel strip, the bracket 304 continues or loops to the beginning of the reel strip.

In the example embodiment, the increments continue until the bracket 304 returns to the reel positions presented in the initial state. That is, the logic circuitry causes the unlocked symbol reel 210 to increment through every symbol on the reel strip. In other embodiments, the logic circuitry increments the unlocked symbol reel 210 through less than or more than (i.e., at least some game outcomes are repeated such that winning outcomes are awarded multiple times) the number of symbols on the unlocked symbol reel 210. In one example, the unlocked symbol reel 210 is incremented through at least a majority of symbols within the unlocked symbol reel 210. The number of increments may be predefined, determined based on one or more parameters (e.g., wager parameters, player account activity, parameters from play of the game, etc.), and/or randomly selected. For embodiments in which the number of increments are dynamic, the number of increments may be determined in response to initiating the bonus game feature or within the bonus game feature (e.g., the logic circuitry determines, after each increment, whether or not additional increments are to be added to the bonus game feature). In the example embodiment, after the game outcomes have been determined, any awards have been provided to the player, and any animations and presentations associated with the increments have concluded, the bonus game feature may be terminated, and play of the base game feature is resumed. Termination of the bonus game feature includes unlocking the locked symbol reels 208, which may be conveyed by removing the border 212 and removing any other difference in presentation between the locked reels 208 and the unlocked reel 210. Other suitable changes in presentation may be used to convey the conclusion of the bonus game feature and/or the return to the base game feature.

The foregoing systems and methods provide a unique and improved game feature in addition to technical improvements to the presentation and administration of game features, particularly in comparison to the complexity of other bonus game features. That is, the incremental outcome feature described above provides the players with a plurality of outcomes at once to increase excitement at a reduced complexity and resource burden comparative to other bonus game features because the outcomes may not rely on additional random-number generation or other resource-intensive outcome determinations beyond the determinations used in the base game feature, thereby reducing the computing, memory, storage, and/or network burden of the bonus game feature on the gaming system. Moreover, the presentation of the bonus game feature may incorporate unique animations and/or graphical elements for presenting the locking and incrementing functions described above that may be different from the presentation elements of at least some known gaming systems.

It is to be understood that although the foregoing systems and methods have described the incremental outcome feature in the context of a bonus game feature, it is to be understood that the game feature may be incorporated into the base game feature in at least some embodiments.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A gaming machine comprising:
a display device configured to present a plurality of symbol positions and a plurality of symbol reels, each symbol reel of the plurality of symbol reels comprising a plurality of symbols and associated with at least one symbol position of the plurality of symbol positions; and
game-logic circuitry configured to:
cause the display device to present a first game outcome by populating each symbol position of the plurality of symbol positions with a symbol from the associated symbol reel of the plurality of symbol reels;
in response to a trigger event, cause the display device to lock at least one symbol reel of the plurality of symbol reels, wherein the symbols of the at least one locked symbol reel that populate the plurality of symbol positions are locked into the respective symbol positions;
cause the display device to present an unlocked symbol reel of the plurality of symbol reels incrementing through at least a majority of the plurality of symbols of the unlocked symbol reel by populating the symbol positions associated with the unlocked symbol reel with a respective new symbol from the plurality of symbols for each increment;
determine, for each increment of the unlocked symbol reel, a game outcome based on the symbols currently populating the plurality of symbol positions; and
cause the display device to present an award animation for any winning game outcomes from the determined game outcomes and the first game outcome.

2. The gaming machine of claim 1, wherein the unlocked symbol reel is incremented through every symbol of the plurality of symbols of the unlocked symbol reel.

3. The gaming machine of claim 1, wherein the trigger event comprises at least one of a trigger symbol, a trigger watermark, or a trigger combination of symbols populating one or more symbol positions of the plurality of symbol positions.

4. The gaming machine of claim 1, wherein the plurality of symbol reels include a second unlocked symbol reel, and wherein the game-logic circuitry is configured to cause the display device to present the second symbol reel incrementing through at least a majority of the plurality of symbols of the second unlocked symbol reel.

5. The gaming machine of claim 1, wherein the plurality of symbol positions are arranged into a symbol array, and each symbol reel of the plurality of symbol reels is associated with a respective column of the symbol array.

6. The gaming machine of claim 5, wherein the display device presents each increment by shifting the symbols populating the respective column by at least one symbol position within the respective column to remove at least one previously presented symbol from the symbol positions of the respective column and add at least one new symbol to the symbol positions of the respective column.

7. The gaming machine of claim 1, wherein the display device includes at least one mechanical reel, each of the at least one mechanical reels representing a respective symbol reel of the plurality of symbol reels.

8. A method for presenting a game using a gaming machine, the method comprising:
presenting, by a display device of the gaming machine, a plurality of symbol positions and a plurality of symbol reels, each symbol reel of the plurality of symbol reels comprising a plurality of symbols and associated with at least one symbol position of the plurality of symbol positions;
causing, by game-logic circuitry of the gaming machine, the display device to present a first game outcome by populating each symbol position of the plurality of symbol positions with a symbol from the associated symbol reel of the plurality of symbol reels;
causing, by the game-logic circuitry and in response to a trigger event, the display device to lock at least one symbol reel of the plurality of symbol reels, wherein the symbols of the at least one locked symbol reel that populate the plurality of symbol positions are locked into the respective symbol positions;
causing, by the game-logic circuitry, the display device to present an unlocked symbol reel of the plurality of symbol reels incrementing through at least a majority of the plurality of symbols of the unlocked symbol reel by populating the symbol positions associated with the unlocked symbol reel with a respective new symbol from the plurality of symbols for each increment;
determining, by the game-logic circuitry and for each increment of the unlocked symbol reel, a game outcome based on the symbols currently populating the plurality of symbol positions; and
causing, by the game-logic circuitry, the display device to present an award animation for any winning game outcomes from the determined game outcomes and the first game outcome.

9. The method of claim 8, wherein the unlocked symbol reel is incremented through every symbol of the plurality of symbols of the unlocked symbol reel.

10. The method of claim 8, wherein the trigger event comprises at least one of a trigger symbol, a trigger watermark, or a trigger combination of symbols populating one or more symbol positions of the plurality of symbol positions.

11. The method of claim 8, wherein the plurality of symbol reels include a second unlocked symbol reel, and wherein the game-logic circuitry is configured to cause the display device to present the second symbol reel incrementing through at least a majority of the plurality of symbols of the second unlocked symbol reel.

12. The method of claim 1, wherein the plurality of symbol positions are arranged into a symbol array, and each symbol reel of the plurality of symbol reels is associated with a respective column of the symbol array.

13. The method of claim 12, wherein the display device presents each increment by shifting the symbols populating the respective column by at least one symbol position within the respective column to remove at least one previously presented symbol from the symbol positions of the respective column and add at least one new symbol to the symbol positions of the respective column.

14. The gaming machine of claim 1, wherein the display device includes at least one mechanical reel, each of the at least one mechanical reels representing a respective symbol reel of the plurality of symbol reels.

15. A gaming system comprising:
a gaming machine including a display device configured to present a plurality of symbol positions and a plurality of symbol reels, each symbol reel of the plurality of symbol reels comprising a plurality of symbols and associated with at least one symbol position of the plurality of symbol positions; and
game-logic circuitry configured to:
cause the display device to present a first game outcome by populating each symbol position of the plurality of symbol positions with a symbol from the associated symbol reel of the plurality of symbol reels;
in response to a trigger event, cause the display device to lock at least one symbol reel of the plurality of symbol reels, wherein the symbols of the at least one locked symbol reel that populate the plurality of symbol positions are locked into the respective symbol positions;
cause the display device to present an unlocked symbol reel of the plurality of symbol reels incrementing through at least a majority of the plurality of symbols of the unlocked symbol reel by populating the symbol positions associated with the unlocked symbol reel with a respective new symbol from the plurality of symbols for each increment;
determine, for each increment of the unlocked symbol reel, a game outcome based on the symbols currently populating the plurality of symbol positions; and
cause the display device to present an award animation for any winning game outcomes from the determined game outcomes and the first game outcome.

16. The gaming system of claim 15, wherein the unlocked symbol reel is incremented through every symbol of the plurality of symbols of the unlocked symbol reel.

17. The gaming system of claim 15, wherein the trigger event comprises at least one of a trigger symbol, a trigger watermark, or a trigger combination of symbols populating one or more symbol positions of the plurality of symbol positions.

18. The gaming system of claim 15, wherein the plurality of symbol reels include a second unlocked symbol reel, and wherein the game-logic circuitry is configured to cause the display device to present the second symbol reel incrementing through at least a majority of the plurality of symbols of the second unlocked symbol reel.

19. The gaming system of claim 15, wherein the plurality of symbol positions are arranged into a symbol array, and each symbol reel of the plurality of symbol reels is associated with a respective column of the symbol array.

20. The gaming system of claim 19, wherein the display device presents each increment by shifting the symbols populating the respective column by at least one symbol position within the respective column to remove at least one previously presented symbol from the symbol positions of the respective column and add at least one new symbol to the symbol positions of the respective column.
